(19) United States
(12) Patent Application Publication
(10) Pub. No.: US 2024/0295004 A1
(43) Pub. Date: Sep. 5, 2024

(54) FURNACE HUMIDIFICATION SYSTEM

(71) Applicant: Cleveland-Cliffs Steel Properties Inc., West Chester, OH (US)

(72) Inventors: Alan D. Poling, Bay Village, OH (US); Shailesh Thakkar, Parma, OH (US); Christopher Heiny, Lakewood, OH (US)

(21) Appl. No.: 18/584,100

(22) Filed: Feb. 22, 2024

Related U.S. Application Data
(60) Provisional application No. 63/449,102, filed on Mar. 1, 2023.

(51) Int. Cl. C21D 9/56; C21D 11/00

(52) U.S. Cl. CPC C21D 9/562; C21D 11/00

(57) ABSTRACT

A steel strip annealing furnace humidification system includes a furnace, a water-injecting system, and a control system. The furnace has a heating region and a soaking region. The water-injecting system is configured to directly feed a liquid into the furnace. The control system is in communication with the water-injecting system to control the feed of liquid into the furnace based on a measured dew point associated with an interior of the furnace.

### PRIORITY

This application claims priority to U.S. Provisional Patent App. No. 63/449,102, entitled “Furnace Humidification System,” filed on Mar. 1, 2023, the disclosure of which is hereby incorporated by reference herein.

### BACKGROUND

The present invention pertains to control of atmospheric properties within an annealing furnace for steelmaking. In a hot dip galvanizing line, there may be a section of the line for annealing the steel strip before it is dipped into the molten zinc bath. Typically, the annealing furnace may include a heating portion and a soaking portion, wherein the steel strip enters and exits the heating portion before entering the soaking portion. Modifying and controlling the atmosphere and the humidity thereof in the annealing furnace is useful in the steelmaking process. In some circumstances, the furnace atmosphere may be humidified by a steam generator. Steam generated by the steam generator may be injected into the furnace separately but is typically mixed with the furnace atmospheric gases and then the mixture is sent into the furnace.

Typically, electric steam generator control requires an approximate 40-minute pre-heat, followed by approximately 20 minutes of “dead” time to respond to a step change in the furnace atmosphere. This slow response of the steam generator method is attributed to the delay of heating water to generate steam, and condensation of the steam in the piping. Periodic cold-water makeup to the generator immediately cools the boiling tank, stopping steam generation until the tank is reheated to boiling. This causes unpredictable steam output interruptions. The generated steam condenses in the steam piping and furnace make-up nitrogen piping, causing a slow response when attempting to raise furnace moisture. Sometimes, once the desired furnace moisture level is reached, the condensed water in the piping will continue to evaporate, causing a large over-shoot condition.

While a variety of water injection systems have been made and used, it is believed that no one prior to the inventor(s) has made or used an invention as described herein.

### DESCRIPTION OF FIGURES

FIG. 1 depicts a schematic view of an annealing furnace;

FIG. 2 depicts a schematic view of an alternative annealing furnace that is substantially similar to the annealing furnace of FIG. 1, but equipped with a humidity control system.

FIG. 3 depicts a schematic view of a humidification control system that may be used with the humidity control system of FIG. 2; and

FIG. 4 depicts a schematic view of a close-loop feedback controller that may be used with the humidification control system of FIG. 2.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

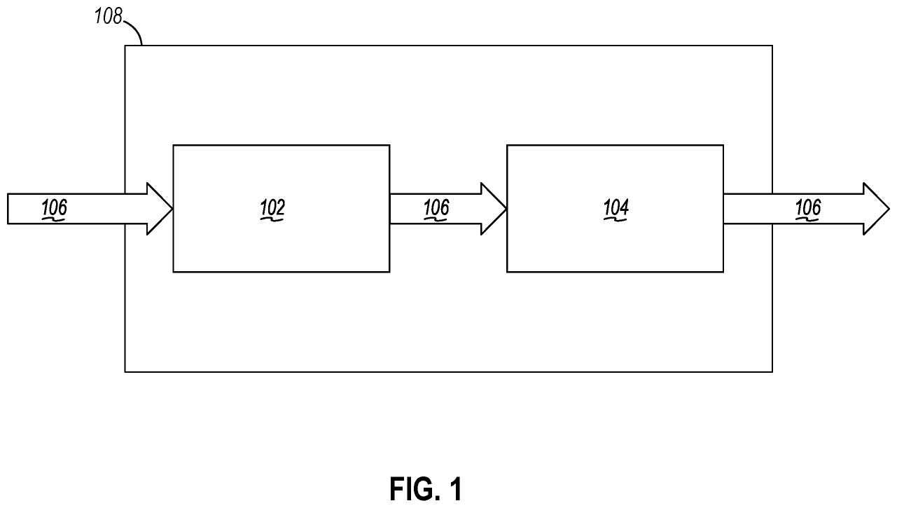

FIG. 1 shows a version of an annealing furnace (108). Annealing furnace (108) includes a first portion, also known as a heating portion (102) and a second portion, also known as a soaking portion (104). Annealing furnace (108) may be combined with other steel processing equipment such as coating systems, quench hardening systems, and/or etc. Heating portion (102) is configured as a furnace large enough to receive at least a portion of a steel strip such that the steel strip may be heated by exposure to a heat source. Soaking portion (104) is similarly configured as a furnace large enough to receive at least a portion of the steel strip such that the steel strip may be heated by exposure to a heat source.

In some versions, heating portion (102) is a radiant tube heating furnace (RTH). The RTH may be assembled by a bracket and a fixture. In some embodiments, the RTH may be composed of a plurality of vertical or horizontal tubes.

Heating portion (102) is configured to facilitate product flow (106) through an interior from one end to another, wherein product flow (106) is heated while in heating portion (102). In versions in which heating portion (102) is an RTH, product flow (106) serpentines up and down the RTH. While in the RTH, product flow (106) is heated to temperatures in the range of 1,200 to 1,650 degrees Fahrenheit. At the end of the RTH, product flow (106) enters soaking portion (104).

In some versions, soaking portion (104) is a radiant tube soak furnace (RTS). The RTS may be assembled by a bracket and a fixture. In some embodiments, the RTS may be composed of a plurality of vertical or horizontal tubes.

Soaking portion (104) is configured to facilitate product flow (106) through an interior from one end to another, wherein product flow (106) is cooled while in soaking portion (104). In versions in which soaking portion (104) is an RTS, product flow (106) serpentines up and down the RTS. While in the RTS, product flow (106) is held to temperatures in the range of 1,200 to 1,650 degrees Fahrenheit.

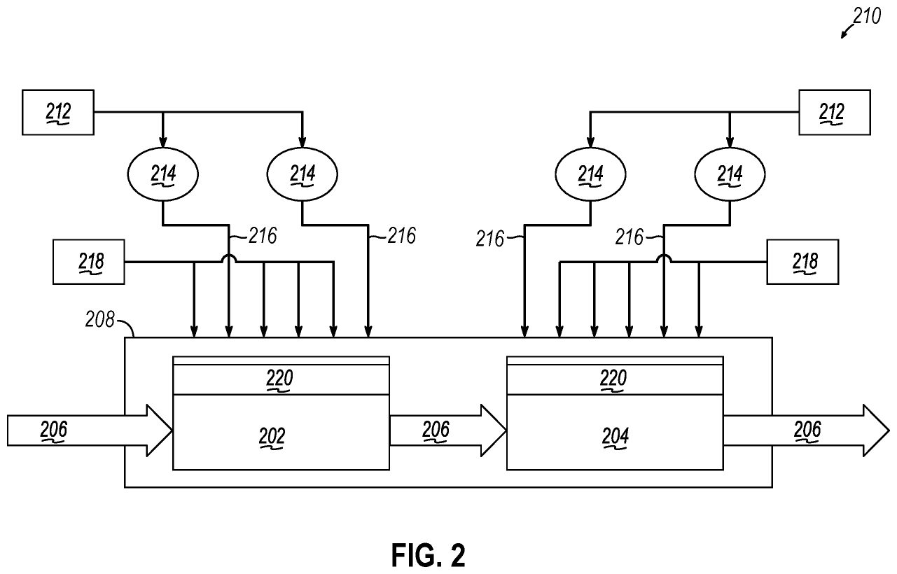

FIG. 2 shows an alternative annealing furnace (208) that is substantially similar to annealing furnace (108) of FIG. 1 but equipped with a humidity control system (210). Annealing furnace (208) includes a heating portion (202), soaking portion (204), and defines a product flow (206) moving from heating portion (202) to soaking portion (204). Annealing furnace (208) includes a humidity control system (210) generally configured to inject liquid into one or more portions of annealing furnace (208). Humidity control system (210) includes a fluid source (212), one or more high accuracy volumetric pumps (214), a plurality of water lines (216), and a plurality of furnace make-up nitrogen lines (218). Plurality of water lines (216) connect the elements of humidity control system (210) to annealing furnace (208). Plurality of water lines (216) connect directly to annealing furnace (208).

Fluid source (212) communicates with high accuracy volumetric pumps (214). In one version, this may include one fluid source (212), a common line, and a plurality of branch lines connecting to each pump. In another version, this may include a fluid source (212) for each pump (214) in direct communication with each pump (214). In another version, this may include a dedicated fluid source (212) for each of the heating portion (202) and soaking portion (204). Fluid source (212) may be a reservoir of demineralized water. Alternatively, fluid source (212) may be a tank.

High accuracy volumetric pumps (214) may be a device that can move fluid by mechanical action, such as converting electrical energy into hydraulic energy. “High accuracy” is defined as an error rate of under 2% volume. In one version, high accuracy volumetric pumps (214) may include precision peristaltic metering pumps with infinitely variable flow control and flow feedback. In another version, high accuracy volumetric pumps (214) may include reciprocating pumps. In another version, high accuracy volumetric pumps (214) may include rotary pumps. In another version, high accuracy volumetric pumps (214) may include power pumps. In another version, high accuracy volumetric pumps (214) may include centrifugal pumps. In versions with more than one volumetric pump, high accuracy volumetric pumps (214) may be synchronized.

Lines connecting the elements of humidity control system (210) to annealing furnace (208) include a plurality of water lines (216). Each water line (216) is in communication with fluid source (212) to communicate fluid from fluid source (212) to annealing furnace (208).

A feed of liquid from a fluid source (212) is fed through one or more high accuracy volumetric pumps (214). High accuracy volumetric pumps (214) control the rate of the output of the liquid. In some versions, the liquid is demineralized water. High accuracy volumetric pumps (214) may be synchronized so that the fluid is being injected at a consistent rate between high accuracy volumetric pumps (214).

After passing through high accuracy volumetric pumps (214), the feed is then injected into both heating portion (102) and soaking portion (104) of annealing furnace (208). Upon entering the furnace, the fluid is vaporized by the elevated temperature of heating portion (202) and soaking portion (204), respectively. This direct injection of fluid into annealing furnace (208) may generate steam instantly or substantially instantly. Within each of heating portion (202) and soaking portion (204), a thermal mass tray (220) may be included to ensure vaporization of the fluid without risk of the water contacting the steel strip. Thermal mass tray (220) may be a metallic plate positioned between product flow (106) and plurality of water lines (216). Thermal mass tray (220) may act as a thermal reservoir to vaporize excess fluid communicated from plurality of water lines (216) and thereby prevent the steel strip from coming into contact with fluid.

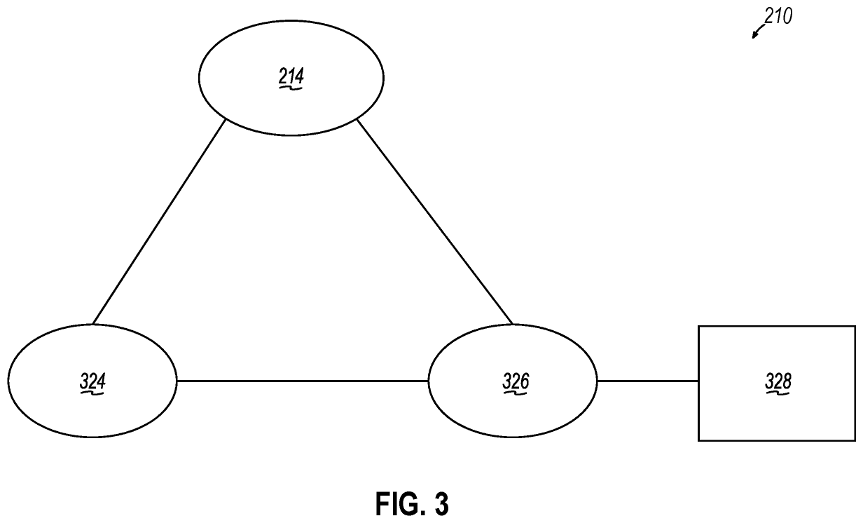

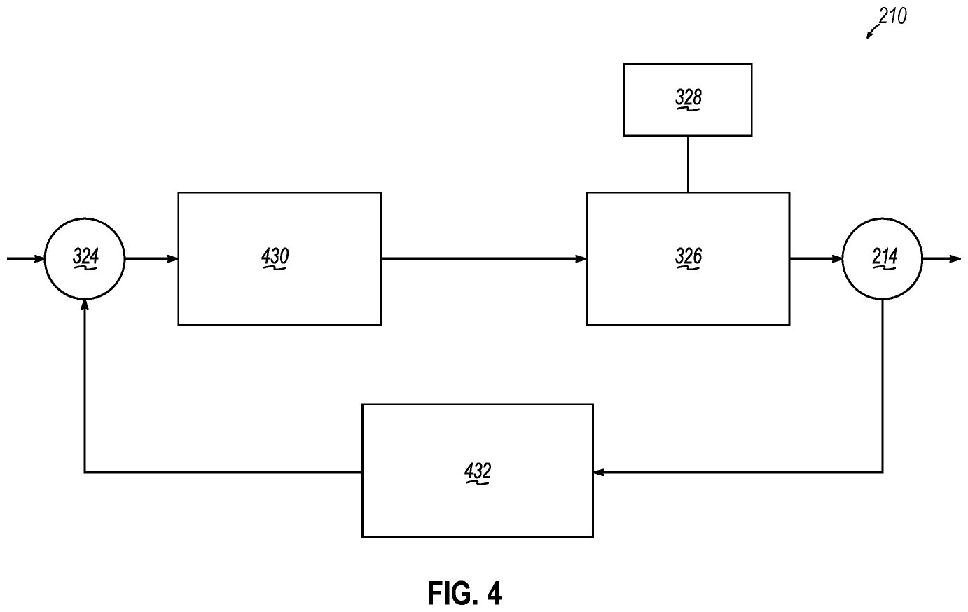

FIGS. 3-4 show a schematic of a humidification control system (210) in the form of a close-loop feedback control unit (432). Humidification control system (210) may be configured to control high accuracy volumetric pumps (214) in FIG. 2, which adjust the output of the feed of fluid and thus the rate of the flow of fluid into annealing furnace (208).

Humidification control system (210) further includes a sensor (324). Sensor (324) is in communication with a portion of the heating portion (202) or soaking portion (204). In one version, sensor (324) is placed at the opposite end of heating portion (202) or soaking portion (204) relative to liquid input. Sensor (324) detects the dew point of the atmosphere in annealing furnace (208) and transmits that measured signal to a processor (326). Sensor (324) may be a single sensor, or there may be a plurality of sensors which measure the local dewpoint and transmit a signal representative of the measured local dew point.

Humidification control system (210) further includes a processor (326) and a memory (328). Processor (326) is further in communication with memory (328), which may be used in combination with processor (326) to facilitate various functions of processor (326).

Memory (328) may include random access memory (RAM), which may be configured for short-term storage of data. Additionally, or in the alternative, memory (328) may further include a solid-state drive or a hard disk drive, which may be configured for long-term storage of data. In versions where memory (328) includes both short-term and long-term storage of data, such short-term and long-term storage elements may be in communication with each other to facilitate transfer of data between short-term storage and long-term storage. In one version, memory (328) may be configured with a programmable logic controller (PLC).

In some versions, processor (326) and memory (328) may communicate with one or more controllers (430) configured in a loop configuration. Controller (430) is configured to receive output from sensor (324) and control high accuracy volumetric pumps (214) based on the output from sensor (324). Controller (430) includes a set point input signal which corresponds to the desired furnace dew point temperature for the specific steel that is within the furnace at a given moment. Controller (430) also receives the feedback signal measured dew point from sensor (324). Controller (430) creates an error signal which it combines with the set point signal to create a control signal for high accuracy volumetric pumps (214) which in turn control the output of the feed of fluid. Controller (430) is further connected to the pump control unit. In one version, controller (430) may transmit PID output signal to the pump control unit, thereby controlling the injection of fluid into the furnace.

In some versions, humidification control system (210) may further include a feedback control unit (432). Feedback control unit (432) calculates an adjustment signal to be added to the PID output signal. The adjustment signal to be added to the PID output signal is calculated based on known upcoming changes in steel grade, steel chemistry, line speed, and steel strip width. In some versions of the present invention, humidification control system (210) may maintain a step response time of less than one minute.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

### Example 1

A steel strip annealing furnace humidification system, comprising: (a) a furnace having a heating region and a soaking region; (b) a water-injecting system configured to directly feed a liquid into the furnace; and (c) a control system in communication with the water-injecting system to control the feed of the liquid into the furnace based on a measured dew point associated with an interior of the furnace.

### Example 2

The system of Example 1, wherein the control system includes one or more proportional-integral-derivative (PID) controllers configured to achieve a close-loop control of the water-injecting system.

### Example 3

The system of Example 1, wherein the control system includes one or more proportional-integral-derivative (PID) controllers, each PID controller of the one or more PID controllers being in communication with the interior of the furnace to provide a closed-loop control of the water-injecting system.

### Example 4

The system of any of Examples 1 through 3, wherein the furnace is configured to have an elevated temperature suitable to vaporize the liquid being fed by the water-injecting system.

### Example 5

The system of any of Examples 1 through 4, wherein the water-injecting system includes a plurality of high accuracy volumetric pumps.

### Example 6

The system of Example 5, wherein the water-injecting system includes four high accuracy volumetric pumps.

### Example 7

The system of Example 6, wherein each high accuracy volumetric pump is in communication with each other high accuracy volumetric pump such that each high accuracy volumetric pump is synchronized with the other high accuracy volumetric pumps.

### Example 8

The system of any of Examples 1 through 7, the furnace including a thermal mass tray disposed within a portion of the furnace, the thermal mass tray being configured to prevent the incoming liquid from contacting steel strip.

### Example 9

The system of any of Examples 1 through 7, the furnace including a thermal mass tray, the thermal mass tray being disposed between one or more liquid ports of the water-injecting system and a material handling section within the interior of the furnace, the thermal mass tray being configured to deflect liquid away from the material handling section of the furnace.

### Example 10

The system of any of Examples 1 through 9, wherein the control system is configured to maintain a step response time of less than one minute.

### Example 11

The system of any of Examples 1 through 10, wherein the liquid being fed into the furnace includes liquid water.

### Example 12

A method for annealing steel that utilizes a furnace humidification system, wherein the system includes a furnace having an upper region and a lower region, the method comprising: (a) feeding a liquid into the furnace using a water injection system; (b) controlling the feed of the liquid into the furnace based on a measured dew point associated with an interior of the furnace using a control system that is in communication with the water-injecting system; and (c) elevating the temperature of the furnace to vaporize the incoming liquid being fed by the water-injecting system.

### Example 13

The method of Example 12, wherein the step of controlling the feed of the liquid includes one or more proportional-integral-derivative (PID) controllers, the one or more PID controllers controlling the feed of the liquid into the furnace using a close-loop control.

### Example 14

The method of Example 12 or 13, wherein the step of feeding the liquid is performed by a plurality of high accuracy water pumps.

### Example 15

The method of Example 14, wherein the step of feeding the liquid includes injecting the liquid through four high accuracy volumetric pumps.

### Example 16

The method of Example 15, wherein the liquid being fed using the four high accuracy volumetric pumps is fed at a consistent rate between the four high accuracy volumetric pumps.

### Example 17

The method of any of Examples 12 through 16, further comprising blocking the liquid being fed into the furnace from contacting steel strip using a thermal mass tray.

### Example 18

The method of any of Examples 12 through 15, wherein the step of controlling the feed of the liquid maintains a step response time of less than one minute.

### Example 19

A continuous annealing line, the continuous annealing line comprising: (a) a furnace including one or more enclosures, the one or more enclosures defining a heating section and a soaking section; (b) a fluid source; (c) one or more gas supply lines in communication with each enclosure of the one or more enclosures; (d) a plurality of pumps in communication with the fluid source; (e) one or more fluid supply lines, each fluid supply line being configured to communicate fluid from a pump of the plurality of pumps to an enclosure of the one or more enclosures, each fluid supply line being separate from the one or more gas supply lines; and (f) a controller in communication with each pump of the plurality of pumps and at least a portion of the furnace, the controller being configured to drive the pumps based on a measured dewpoint within the furnace.

### Example 20

The continuous annealing line of Example 19, further comprising a thermal mass tray and a plurality of fluid ports, the thermal mass tray being disposed in the heating section, the soaking section or both of the one or more enclosures of the furnace, each fluid port of the plurality of fluid ports being disposed within the heating section or soaking section of the furnace and in communication with a respective fluid supply line, the thermal mass tray being disposed opposite at least one fluid port of the plurality of fluid ports within each enclosure of the one or more enclosures, each fluid port being configured to communicate a fluid in liquid form into the furnace via the fluid supply lines, the thermal mass tray being configured to deflect the fluid communicated into the furnace via one or more of the fluid ports.

1. A steel strip annealing furnace humidification system, comprising:
(a) a furnace having a heating region and a soaking region;
(b) a water-injecting system configured to directly feed a liquid into the furnace; and
(c) a control system in communication with the water-injecting system to control the feed of the liquid into the furnace based on a measured dew point associated with an interior of the furnace.

2. The system of claim 1, wherein the control system includes one or more proportional-integral-derivative (PID) controllers configured to achieve a close-loop control of the water-injecting system.

3. The system of claim 1, wherein the control system includes one or more proportional-integral-derivative (PID) controllers, each PID controller of the one or more PID controllers being in communication with the interior of the furnace to provide a closed-loop control of the water-injecting system.

4. The system of claim 1, wherein the furnace is configured to have an elevated temperature suitable to vaporize the liquid being fed by the water-injecting system.

5. The system of claim 1, wherein the water-injecting system includes a plurality of high accuracy volumetric pumps.

6. The system of claim 5, wherein the water-injecting system includes four high accuracy volumetric pumps.

7. The system of claim 6, wherein each high accuracy volumetric pump is in communication with each other high accuracy volumetric pump such that each high accuracy volumetric pump is synchronized with the other high accuracy volumetric pumps.

8. The system of claim 1, the furnace including a thermal mass tray disposed within a portion of the furnace, the thermal mass tray being configured to prevent the incoming liquid from contacting steel strip.

9. The system of claim 1, the furnace including a thermal mass tray, the thermal mass tray being disposed between one or more liquid ports of the water-injecting system and a material handling section within the interior of the furnace, the thermal mass tray being configured to deflect liquid away from the material handling section of the furnace.

10. The system of claim 1, wherein the control system is configured to maintain a step response time of less than one minute.

11. The system of claim 1, wherein the liquid being fed into the furnace includes liquid water.

12. A method for annealing steel that utilizes a furnace humidification system, wherein the system includes a furnace having an upper region and a lower region, the method comprising:
(a) feeding a liquid into the furnace using a water injection system;
(b) controlling the feed of the liquid into the furnace based on a measured dew point associated with an interior of the furnace using a control system that is in communication with the water-injecting system; and
(c) elevating the temperature of the furnace to vaporize the incoming liquid being fed by the water-injecting system.

13. The method of claim 12, wherein the step of controlling the feed of the liquid includes one or more proportional-integral-derivative (PID) controllers, the one or more PID controllers controlling the feed of the liquid into the furnace using a close-loop control.

14. The method of claim 12, wherein the step of feeding the liquid is performed by a plurality of high accuracy water pumps.

15. The method of claim 14, wherein the step of feeding the liquid includes injecting the liquid through four high accuracy volumetric pumps.

16. The method of claim 15, wherein the liquid being fed using the four high accuracy volumetric pumps is fed at a consistent rate between the four high accuracy volumetric pumps.

17. The method of claim 12, further comprising blocking the liquid being fed into the furnace from contacting steel strip using a thermal mass tray.

18. The method of claim 12, wherein the step of controlling the feed of the liquid maintains a step response time of less than one minute.

19. A continuous annealing line, the continuous annealing line comprising:
(a) a furnace including one or more enclosures, the one or more enclosures defining a heating section and a soaking section;
(b) a fluid source;
(c) one or more gas supply lines in communication with each enclosure of the one or more enclosures;
(d) a plurality of pumps in communication with the fluid source;
(e) one or more fluid supply lines, each fluid supply line being configured to communicate fluid from a pump of the plurality of pumps to an enclosure of the one or more enclosures, each fluid supply line being separate from the one or more gas supply lines; and
(f) a controller in communication with each pump of the plurality of pumps and at least a portion of the furnace, the controller being configured to drive the pumps based on a measured dewpoint within the furnace.

20. The continuous annealing line of claim 19, further comprising a thermal mass tray and a plurality of fluid ports, the thermal mass tray being disposed in the heating section, the soaking section or both of the one or more enclosures of the furnace, each fluid port of the plurality of fluid ports being disposed within the heating section or soaking section of the furnace and in communication with a respective fluid supply line, the thermal mass tray being disposed opposite at least one fluid port of the plurality of fluid ports within each enclosure of the one or more encloses, each fluid port being configured to communicate a fluid in liquid form into the furnace via the fluid supply lines, the thermal mass tray being configured to defect the fluid communicated into the furnace via one or more of the fluid ports.
